(19) United States
(12) Patent Application Publication
(10) Pub. No.: US 2008/0060991 A1
(43) Pub. Date: Mar. 13, 2008

(54) Combination valve including anti-drainback valve with slits

(76) Inventor: John D. Gaither, West Salem, IL (US)

Correspondence Address: Olson & Cepuritis, LTD., 20 NORTH WACKER DRIVE, 36TH FLOOR, CHICAGO, IL, 60606, US

(21) Appl. No.: 11/518,779

(22) Filed: Sep. 11, 2006

(51) Int. Cl. B01D 35/00

(52) U.S. Cl. 210/424; 210/433.1; 210/443; 210/450

(57) ABSTRACT

A filter assembly has a housing closed at one end and open at the other end. An annular filter media/core assembly including first and second end caps is disposed in the housing. An end plate having a plurality of first and second inlet openings and an outlet opening is disposed in the open end of the housing. A combination valve, which is retained between the second end cap of the filter media/core assembly and the end plate, has a first anti-drainback portion that cooperates with the first inlet openings in the end plate and a second bypass portion that cooperates with the second inlet openings. One or more slits are provided in a circle in the first anti-drainback portion. The slits are constructed and arranged to cooperate with the first inlet openings to open to allow fluid flow through the first anti-drainback portion in a reverse direction during initial engine fill, and to close and provide a functional seal when the first anti-drainback portion operates normally. In normal use, fluid will pass through the first inlet openings, the filter media/core assembly and be discharged from the housing through the outlet opening. When the filter media begins to clog, pressure will build and upon attainment of a predetermined pressure the second bypass portion will open the second inlet openings and fluid flow can pass through the second inlet openings to the outlet opening, for discharge from the filter assembly, thereby bypassing the filter media.

### BACKGROUND OF THE INVENTION

A. Field of the Invention

This invention pertains to a fluid filter assembly having a combination valve retained between a filter media/core assembly and an end plate and, more particularly, to a fluid filter assembly having a novel unitary combination anti-drainback valve and bypass valve cooperating with a unique end plate for controlling the flow of fluid into and out from the fluid filter assembly. Further, the invention pertains to a combination anti-drainback valve and bypass valve, wherein the anti-drainback valve has slits therein constructed and arranged to open to allow fluid flow through the fluid filter assembly in a reverse direction during initial engine fill and to close and provide a functional seal when the anti-drainback valve functions normally in operation.

B. Description of Related Art

There is known in the prior art a filter device having a housing with an open end, a filter element received in the housing, an end plate closing the open end and having inlet and outlet openings therein, and a valve for cooperating with the inlet openings to allow oil to flow into the filter through the inlet openings, but prevents flow of oil in a reverse direction. An example may be seen in Minowa et al. U.S. Pat. No. 6,595,372. Prior filters are known that include a combination valve having two portions, the first portion for closing the inlet openings to block the flow of oil back out of the inlet openings when the oil is not being circulated and the second portion for opening a bypass opening when the filter media is clogged for returning oil to the engine to keep the engine lubricated even though the filter element is clogged. An example of such construction is Covington U.S. Pat. No. 5,405,527.

A combination anti-drainback and bypass valve has been proposed that eliminates many prior art shortcomings, however, it has been found that a problem can arise during initial engine fill. Some original equipment manufacturers desire to reverse oil flow through the filter to prime the oil pump prior to starting the engine. This is not possible with the anti-drainback valve in place. Therefore, many first fit filters do not contain an anti-drainback valve. This can potentially cause dry starts in the field, engine knock, and complaints from users. It is desired to provide a unique combination valve with a feature to permit reverse oil flow through the filter to prime the oil pump prior to starting the engine.

While the present invention improves upon the filter assembly with combination anti-drain and bypass valve, shown for example, in the Covington U.S. Pat. No. 5,405,527 and overcomes disadvantages and deficiencies of such prior art constructions, there is need for a fluid filter assembly with a unitary combination anti-drainback and bypass valve that will allow fluid flow through the filter in a reverse direction during initial fluid fill and will function as an anti-drainback valve in normal operation.

### SUMMARY OF THE INVENTION

An object of the present invention is to provide an improved filter assembly that has a simpler design and fewer parts than prior art filter assemblies.

Another object of the present invention is to provide an improved filter assembly having a unitary anti-drainback and bypass valve, with the anti-drainback valve having slits therein constructed and arranged to open to allow fluid flow through the fluid filter assembly in a reverse direction during initial engine fill and to close and provide a seal when the anti-drainback valve functions normally in operation

Yet another object of the present invention is to provide an improved filter assembly having a unitary combination valve with cross-cut slits in the anti-drainback valve portion of the combination valve, said cross-cut slits being constructed and arranged to open to allow fluid flow through the fluid filter assembly in a reverse direction during initial engine fill and to close and provide a seal when the anti-drainback valve functions normally in operation.

A further object of the present invention is to provide a filter assembly having a housing with a closed end and an open end, with an end plate in the open end of the housing and a filter and a combination valve in the housing, the end plate having inlet openings and at least one outlet opening, the anti-drainback valve portion of the combination valve having slits therein, the slits being mated with inlet openings in the end plate.

Other objects and advantages of the present invention will become more apparent hereinafter.

The invention pertains to a filter assembly having a housing open at one end and closed at the other end. The end plate has at least two inlet openings and an outlet opening therein. A unitary combination valve is disposed and retained between the filter media/core assembly and the end plate. The combination valve has a first portion or anti-drainback portion cooperating with the first inlet opening in the end plate and a second portion or bypass portion cooperating with the second inlet opening. In normal operation the first portion of the combination valve will yield before the second portion of the combination valve and fluid flow will pass through the first inlet opening, the filter element and then be discharged through the outlet opening. When the filter element begins to clog, pressure upstream of the first portion will build and upon attainment of a predetermined pressure, the second portion will open the second inlet opening and fluid flow can pass through the second inlet opening and out the outlet opening, thereby bypassing the filter media/core assembly. Further, the anti-drainback valve portion has slits therein constructed and arranged to open to allow fluid flow through the fluid filter assembly in a reverse direction during initial engine fill and to close and provide a functional seal when the anti-drainback valve portion functions normally in operation.

### BRIEF DESCRIPTION OF THE DRAWING

There is shown in the attached drawing a presently preferred embodiment of the present invention wherein like numerals refer to like elements and wherein:

FIG. 1 is a vertical cross-section view of the filter assembly of the present invention, with part of the housing broken away to show interior parts including the combination check and bypass valve;

FIG. 2 is a perspective view of the combination anti-drainback valve and bypass valve, illustrating slits in the anti-drainback valve portion;

FIG. 3 is a bottom view of the combination anti-drainback valve and bypass valve;

FIG. 4 is a detail cross-sectional view taken along the line 4-4 of FIG. 3; and

FIG. 5 is a bottom view of the end plate of the filter assembly of FIG. 1.

### DETAILED DESCRIPTION OF THE INVENTION

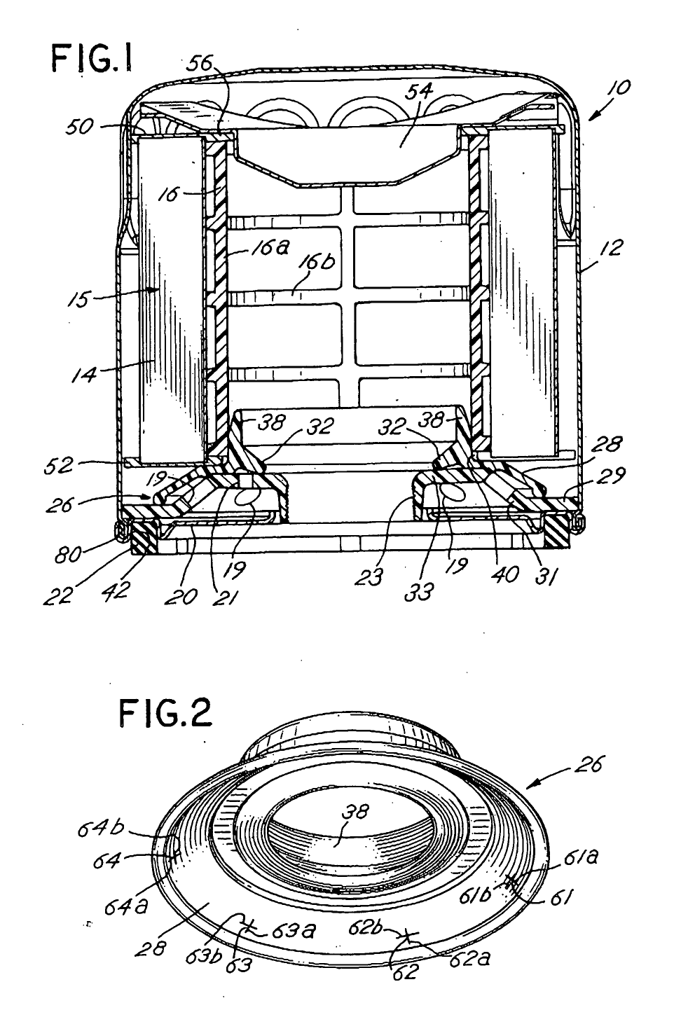

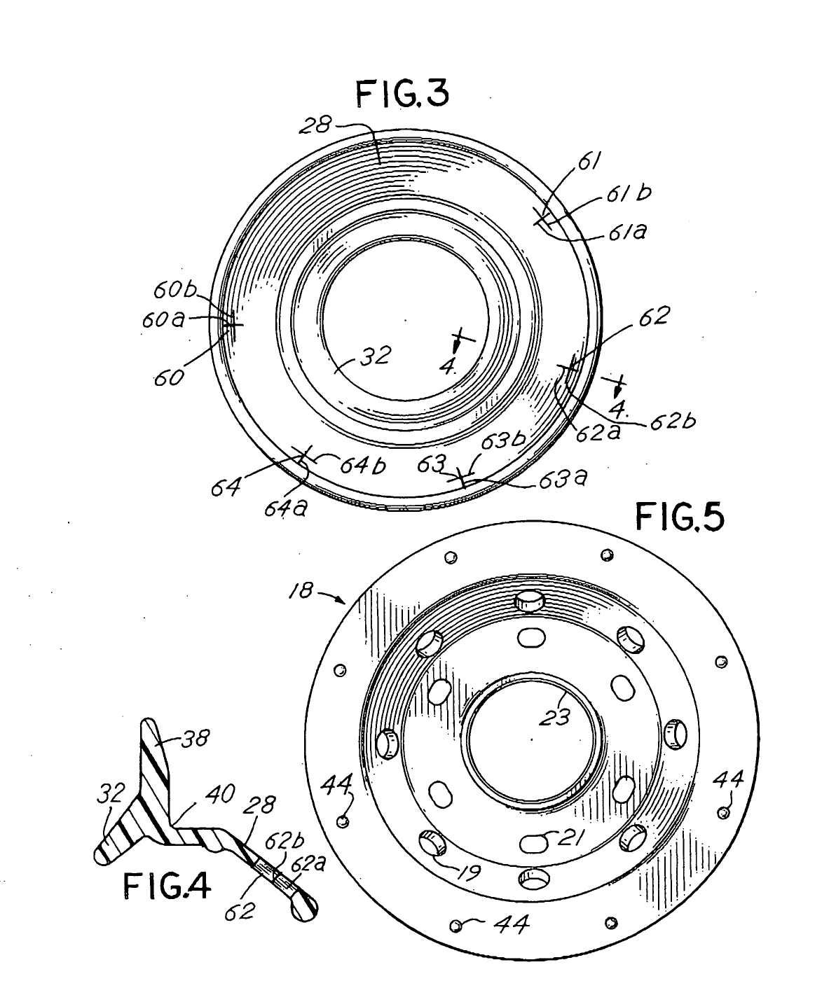

There is shown in FIG. 1 a filter assembly embodying the present invention. The filter assembly 10 includes a generally cup-shaped cylindrical shell or housing 12 that is open at one end and closed at the other. Disposed within the housing 10 is a filter means 15 which comprises an annular filter element 14 mounted on a core 16. Provided in the open end of the housing 10 is an end plate 18, which has a lid 20 secured thereto. The end plate 18 includes a plurality of inlet openings 19 and 21 and at least one outlet opening 23. In one present embodiment there are eight openings 19 equally spaced from one another and arranged along a circle and six openings 21 equally spaced from one another and arranged along a circle (see FIG. 5). An annular, resilient gasket 22 is received and retained in a recess in the lid 20 for providing a seal between the filter assembly 10 and the engine block (not shown) to which the filter assembly 10 is secured in normal use.

The combination valve 26, which is retained between the lower end of the filter element 14 and the top of the end plate 18, is unitary in construction, for example, by molding, and includes a first anti-drainback portion 28 for controlling flow through the first inlet opening or openings 19 and a second bypass portion 32 for controlling flow through the second inlet opening or openings 21. The first portion 28 is more resilient than the second portion 32 and will open under a lesser pressure, whereas the second portion 32 is stiffer and requires a higher pressure to open same. In a presently preferred embodiment of the invention, the first portion 28 of the combination valve 26 will open the first inlet openings 19 at a minimum opening pressure, for example, on the order of 1 psi and the second portion 32 will open the second inlet opening 21 at a predetermined higher pressure, for example on the order of 8-10 psi. Provided centrally in the end plate 18 is a central threaded outlet opening 23. The outlet opening 23 is disposed about the longitudinal axis of the filter assembly 10 and is within the circle of second openings 21. In a presently preferred embodiment of the invention, there are eight first inlet openings 19 and six second inlet openings 21 in the end plate 18. Other opening configurations than round are feasible and the number of openings can be varied as will be apparent to persons skilled in the art, depending upon the application for the filter assembly 10.

The combination valve 26 of the present invention includes a first portion 28 that is annular and has a bend intermediate the radial extent of the first portion 28. The part of the first portion 28 that engages the second portion 32 extends generally horizontally and the free end is inclined outwardly and downwardly from the horizontal portion. The second portion 32 includes an annular inwardly inclined part that is adapted to cooperate with the second inlet openings 21 and an upwardly extending part 38 that cooperates with the horizontal part of the first portion 28 to form a shoulder 40 that receives the lower inner end of the core 16 of the filter means 15. The part 38 is annular and engages the interior of the lower end of the core 16 of the filter means when assembled. The combination valve 26 is formed unitarily, e.g., by molding, from a suitable material, e.g., nitrile or silicone rubber compound.

The end plate 18 is suitably secured to the lid 20, for example, by welding. Projections 44 extend from the bottom of the end plate 18 to facilitate the connection of the end plate 18 to the lid 20. The recess 42 in the lid 20 is adapted to receive and retain the gasket 22 (FIG. 1). The lid 20 may be provided with projections that slightly interfere with the recess 42, whereby in use, the gasket 22 is forced into the recess 42 and retained in place by the pressure from the projections engaging and cooperating with the resilient gasket 22.

The resilient gasket 22 will be retained in the recess or groove 42 during handling of the filter assembly 10 and the projections (not shown) define cooperative engaging means for holding the gasket in place. Persons skilled in the art will understand that the gasket 22 can be similarly retained in place in the recess 42 if the projections on the lid 20 were eliminated and projections were provided on the outside or inside surfaces of the gasket 22 for engaging with the walls of the recess 42. Such arrangement would function in an equivalent manner.

The end plate 18, as seen in FIGS. 1 and 5, is comprised of an outer generally transverse portion 29, an inclined portion 31 and an inner transverse portion 33. Openings 21 are disposed in a circle in the generally horizontal or transverse portion 33 of the end plate 18 and each has an axis that is generally parallel to the central longitudinal axis of the filter assembly 10. Openings 19 are disposed in a circle generally concentric to the circle for the openings 21 and spaced outwardly there from. The openings 19 are in the angled outward portion 31 of the end plate 18 and the axis of each of the openings 19 is inclined with respect to the central longitudinal axis of the filter assembly 10.

The filter means 15 may comprise a conventional pleated filter media 14 composed, for example, of cellulose with some polyester. The core 16, which may be molded from an appropriate material, for example, a glass filled plastic, such as, Nylon, is perforated so as to permit fluid flow there through in use. Essentially, the core 16 comprises a cage formed by vertically disposed members 16a suitably secured to horizontally disposed members 16b. The filter media 14 is formed from a sheet of pleated material joined along the facing ends by a suitable adhesive to form an annular sleeve on the cage 16.

At the top and bottom are disposed end caps 50 and 52, respectively. The end caps 50 and 52 may be fabricated from a suitable composite material, for example a cellulose/polyester composite. Preferably, the end caps 50 and 52 are bonded to the filter media 14, for example, by ultrasonic welding, to form a seal between the ends of the filter media and the end caps to prevent fluid flow between these elements in use. Essentially the materials for the filter media 14, the core 16, and the end caps 50 and 52 are compatible for ultrasonic welding to fuse the parts to one another. This process eliminates the need for adhesive and the oven curing that was done in the past. The top end cap 50 is a generally annular plate that has an opening in the center thereof for receiving and engaging a spring member 54 to help bias or urge the filter means 15 in the housing 12 toward the end plate 18. The bottom end cap 52 is a generally annular plate that has an opening in the center thereof and projections (not shown) extending from the periphery thereof. As disclosed in the prior co-pending application, there are three projections on the end cap 52. The projections are adapted to abut the interior of the housing 12 to facilitate assembly of the filter means into the housing 12 and to properly position the lower portion of the filter means 15 in the housing 12.

A resilient seal 56 is disposed between the top end cap 50, the core 16 and the spring 54 to preclude fluid flow between these elements. The seal 56 may be composed of felt or felt-like material. The opening in the center of the annular filter media 14 will be closed to fluid flow by the center portion of the spring 54 when the filter means 15 is assembled in the housing 12. The resiliency of the seal 56 will apply a downward biasing force to the filter means 15. The lower part of the core 16 will engage the outer surface of the upwardly extending part 38 of the combination valve 26 to seal between the lower end of the filter and the combination valve 26.

In accord with the present invention the anti-drainback portion 28 of the combination valve 26 is provided with a plurality of cross cut slits 60-64 constructed and arranged to open to allow fluid flow through the fluid filter assembly in a reverse direction during initial engine fill and to close and provide a seal when the anti-drainback valve operates normally in operation. In the illustrated embodiment, there are five (5) slits arranged in a non-symmetrical pattern. The cross cut slit 60 includes a first generally radial slit 60a and a slit 60b transverse thereto. The slits 60a and 60b extend through the anti-drainback portion 28 of the combination valve 26. Slits 61, 62, 63 and 64 are similarly formed in the anti-drainback portion 28 of the combination valve 26. Though the slits 60-64 are intended to operate only during initial oil fill they perform an important function that is desired by users of the filter assembly 10. Thereafter the filter assembly functions normally, with the slits 60-64 being effectively closed to fluid flow.

The slits 60-64 are asymmetrically formed in the anti-drainback portion 28 of the combination valve 26. It is desired that at least one cross cut slit be aligned with an opening 19 in the end plate 18 when the filter assembly 10 is assembled, with the fewest number of cross cuts in the combination valve 26. In a presently preferred embodiment there are five cross cut slits 60-64. Radial slits 60a and 61a, 61a and 62a, 62a and 63a, and 63a and 64a are each offset from one another by 54 degrees. Radial slits 64a and 60a are offset by 144 degrees. With the five cross cuts in the anti-drainback valve portion 28 of the combination valve 26 and the eight equally spaced openings 19 in the end plate 18, the equivalent of one cross cut slit is over an opening 19 at all times. This is accomplished by one cross cut slit being over an opening 19, or by one-half of a cross cut slit being over one opening and one-half of a cross cut slit being over another opening 19, or three quarters of one cross cut slit being over one opening 19 and one quarter of another cross cut slit being over another opening 19, etc. The radial slits and the transverse slits of each cross-cut slit 60-64 are each about 0.200 inch long and extend through the anti-drainback portion 28 of the combination valve 26. The slits 60-64 are constructed and arranged so as to provide a functional leak free part in normal use of the combination valve 26. The slits 60-64 open only during initial engine fill.

The assembly of the filter assembly 10 will now be described. The filter means 15 is assembled with the annular filter media 14 on the core 16 and the end caps 50 and 52 secured in place. The end plate 18 and the lid 20 are secured together, for example, by welding, and the gasket 22 is positioned and retained in the recess 42 of the lid. The filter means 15 is positioned in the housing 12 abutting the spring 54, which is engaged in the upper end of the filter means 15 help to properly center the top of the filter means 15 in the housing 12. The seal 56 will preclude fluid flow between the filter means 15 and the housing 12. The combination valve 26 is positioned in the core 16 with the part 38 engaging the inner surface of the core 16 to help seal fluid flow between the combination valve 26 and the core 16 of the filter means. The end plate 18 is inserted to close the open end of the housing 12 and the outer rim of the lid 20 is rolled with the open end of the housing 12 to form a seal 80. Positioning of the end plate 18 in the housing 12 partially compresses the seal 56, whereby, when the parts are assembled an additional spring force is applied to the filter means 15 urging the filter means toward the end plate 18. The combined forces of spring 54 and seal 56 will help to retain the combination valve 26 between the filter means 15 and the end plate 18 and to seal flow from between the filter means and the end plate 18. The core 16 will firmly engage the part 38 of the combination valve 26 and will also engage and bear upon the generally horizontal region of the first portion 28 of the combination valve 26.

In operation, the filter assembly 10 is spun onto a stud on the engine block which engages the threads in the central opening 36 in the end plate 18 and is secured in place. The gasket 22 will engage the engine block and preclude fluid flow from between the engine block and the filter assembly 10. Original equipment engine plants desire to flow oil through the filter to prime the oil pump prior to starting the engine. This is not possible with conventional filters having an anti-drainback valve in place because the anti-drainback valve prevents reverse flow through the filter. Therefore, many first fit filters do not contain an anti-drainback valve. This can potentially cause dry starts in the field, engine knocks and customer complaints. With the inventive combination valve 26 in place, fluid flow through the outlet opening 23 and through the filter media 14 can exit via the cross cut slits 60-64 in the anti-drainback valve 26. The slits 60-64 are positioned so as to always have the equivalent of one slit mated with an opening or openings 19 in the threaded plate or end plate 18. The slits 60-64 open and allow flow in the reverse direction during initial engine fill, but close and provide an adequate seal when the combination valve is functioning normally. When the engine is started, fluid, usually oil, will enter the filter assembly through the openings 19. Slight pressure will move the anti-drainback portion or check valve portion 28 of the combination valve 26 away from the openings 19 and oil will flow through openings 19, the filter media 14 and be discharged through the central outlet opening 23 for return to the engine. When the engine is turned off, the first anti-drainback portion or check valve portion 28 of the combination valve 26 will close the openings 19 and prevent return of oil in the filter assembly 10 to the engine. As the filter media 14 clogs during normal operation, pressure will build within the housing 12 of the filter assembly 10 and upon attainment of a predetermined pressure, on the order of 8-10 psi for one present application, the second portion or bypass portion 32 of the combination valve 26 will open and permit oil to flow through the openings 21 and outlet opening 23 back to the engine, thereby bypassing the filter media 14. Stated somewhat differently, during periods of time when high differential pressure exists across the filter media, due to cold thick oil or high contaminant loading of the filter media, the oil will go through the inner circle of openings 21 and open the second portion 32 of the combination valve 26 to permit oil to bypass the filter media 14 and exit the filter assembly 10 through the outlet opening 23 for return to the engine.

The present invention materially reduces the number of parts needed for a line of filters. Presently standard automotive filter assemblies are grouped into multiple filter diameters. A main line of filter assemblies heretofore consisted of multiple core diameters and multiple core heights. With the present invention, filter sizes can be consolidated and the complexity of internal components can be reduced significantly, for example to one core diameter and two core heights. Fabrication and assembly of the filter assemblies are simplified and can easily be automated. The filter media, core and end caps are non-metallic and can be easily recycled. The unique end cap design and orientation of the openings therein is a facilitating factor in both construction and operation of the filter assembly. The construction of the combination anti-drainback valve and bypass valve and the cooperation of the combination anti-drainback valve and bypass valve with the end plate contribute to easier assembly and enhanced performance. The respective circles of openings in the end plate are fairly close to one another. The combination valve is constructed so that it can be retained in place against the end plate by the core 16 of the filter means by contact between the two circles of openings. This arrangement seals fluid flow through one circle of openings from the fluid flow through the other circle of openings. Tolerances need not be tight to obtain the sealing results desired. The slits in the anti-drainback portion of the combination valve 26 cooperate with the inlet openings 19 in the end plate 18 to permit flow in the reverse direction during initial engine fill and thereby permit use of a filter assembly that includes a combination valve that with an anti-drainback portion.

While it will be understood by persons skilled in the art that the spring 54 could be eliminated and that a concave portion could be provided in the closed end of the housing to help reduce the overall height of the filter assembly, such modification of the filter assembly would not affect the operation of the combination anti-drainback and bypass valve of the present invention.

While a presently preferred embodiment of the present invention has been shown and described, it will be apparent to persons skilled in the art that the invention may be otherwise embodied within the scope of the following claims.

I claim:

1. A filter assembly having a housing open at one end and closed at the other end, an annular filter media/core assembly disposed in said housing, an end plate secured to the housing and closing the open end thereof, the end plate having first inlet opening means, second inlet opening means and outlet opening means, a combination valve disposed between the annular filter media/core assembly and the end plate for controlling fluid flow through the first inlet opening means and the second inlet opening means, the combination valve including a first portion cooperating with the first inlet opening means and a second portion cooperating with the second inlet opening means, the second portion having more resistance to fluid flow than the first portion, whereby, in normal operation, the first portion will yield prior to the second portion and fluid flow will pass through the first inlet opening means, the annular filter media/core assembly and then be discharged through said outlet opening means and when the annular filter media/core assembly begins to clog, pressure upstream of the first portion will build and upon attainment of a predetermined pressure, the second portion will open the second inlet opening means and fluid flow can pass through the second inlet opening means and out the outlet opening means bypassing the annular filter media/core assembly, said first portion having slits therein constructed and arranged to open to allow fluid flow through the first portion in a reverse direction during initial engine fill, and to close and provide a seal when the first portion operates normally.

2. A filter assembly as in claim 1, including resilient means disposed between the top of the annular filter media/core assembly and the inner surface of the housing for biasing the annular filter media/core assembly toward the end plate.

3. A filter assembly as in claim 1, wherein the combination valve comprises a unitary annular member, with the first portion extending outwardly from a central portion and the second portion extending inwardly from the central portion, the second portion being stiffer than the first portion; the annular filter media/core assembly engaging the central portion of the combination valve between the first portion and the second portion to retain the combination valve in place.

4. A filter assembly as in claim 1, wherein the end plate has an inclined surface inclined with respect to the longitudinal axis of the housing and a transverse surface transverse to the longitudinal axis of the housing, the first inlet opening means being disposed in the inclined surface and the second inlet opening means being disposed in the transverse surface.

5. A filter assembly as in claim 1, wherein the first inlet opening means comprises a plurality of openings.

6. A filter assembly as in claim 5, wherein there are eight first inlet openings in the end plate and five slits in the first portion of the combination valve, at least one slit in the first portion of the combination valve being constructed and arranged to be aligned with a first inlet opening when the filter assembly is assembled.

7. A filter assembly as in claim 1, wherein the second inlet opening means comprises a plurality of openings.

8. A filter assembly as in claim 1, wherein the slits comprise cross cut slits.

9. A filter assembly as in claim 8, wherein the cross cut slits are constructed and arranged such that at least the equivalent of one slit is aligned with a first inlet opening means.

10. A filter assembly as in claim 6 wherein the slits are constructed and arranged such that at least the equivalent of one slit is aligned with an opening or openings in the end plate.

11. A filter assembly having a housing opening at one end and closed at the other end, an annular filter media/core assembly disposed in said housing and having a central opening in the upper end thereof, resilient means between the inner surface of the housing and the annular filter media/core assembly, an end plate secured to the housing, the resilient means biasing the annular filter media/core assembly toward the end plate, the end plate having first inlet openings, second inlet openings and an outlet opening the open end thereof, and a combination valve disposed between the annular filter media/core assembly and the end plate for controlling fluid flow through the first and second inlet openings, the combination valve including a first anti-drainback portion cooperating with the first inlet openings and a second bypass portion cooperating with the second inlet openings, the second portion having more resistance to fluid flow than the first portion, whereby in operation, the first anti-drainback portion will yield in response to minimum pressure and fluid flow will pass through the first inlet openings, the annular filter media/core assembly and then be discharged through the outlet opening and when the annular filter media/core assembly begins to clog, pressure will begin to build and upon attainment of a higher predetermined pressure, the second bypass portion will open the second inlet openings and fluid flow can pass through the second inlet openings and out the outlet opening, bypassing the annular filter media/core assembly, said first anti-drainback portion having slits therein constructed and arranged to open to allow fluid flow through the first anti-drainback portion in a reverse direction during initial engine fill, and to close and provide a functional seal when the first anti-drainback portion operates normally.

12. A filter assembly as in claim 11 wherein the combination valve comprises an annular member, with the first anti-drainback portion extending outwardly from a central portion and the second bypass portion extending inwardly from the central portion, the second bypass portion being stiffer than the first anti-drainback portion, the annular filter element engaging the central portion of the combination valve between the first portion and the second portion to retain the combination valve in place.

13. A filter assembly as in claim 11 wherein the second inlet opening means comprises a plurality of openings.

14. A filter assembly as in claim 11, wherein the slits comprise cross slits, each including a radial portion and a transverse portion.

15. A filter assembly as in claim 11, wherein the slits are constructed and arranged such that the equivalent of one slit is mated with the first inlet opening means.

16. A filter assembly as in claim 11, wherein the slits are constructed and arranged such that at least one slit is mated with a first inlet opening in the end plate.

17. A combination valve for use in a filter assembly that houses an annular filter media/core assembly and includes an end plate having first inlet opening means, second inlet opening means, and outlet opening means, said combination valve being unitary and including a first portion adapted to cooperate with the first inlet opening means and a second portion adapted to cooperate with the second inlet opening means, the second portion having more resistance to fluid flow than the first portion, whereby, in normal operation, the first portion will yield prior to the second portion and fluid flow will pass through the first inlet opening means, the annular filter media/core assembly and then be discharged through said outlet opening means and when the annular filter media/core assembly begins to clog, pressure upstream of the first portion will build and upon attainment of a predetermined pressure, the second portion will open the second inlet opening means and fluid flow can pass through the second inlet opening means and out the outlet opening means bypassing the annular filter media/core assembly, said first portion having slits therein constructed and arranged to open to allow fluid flow through the first portion in a reverse direction during initial engine fill, and to close and provide a seal when the first portion operates normally.

18. A combination valve as in claim 17, wherein the slits comprise cross cut slits.

19. A combination valve as in claim 18, wherein there are five cross cut slits constructed and arranged to cooperate with eight first inlet opening means such that the equivalent of at least one cross cut slit is adapted to be aligned with the first inlet opening means.

20. A combination valve as in claim 17, wherein the slits are constructed and arranged asymmetrically along a circle such that at least one slit is adapted to be mated with an opening in the first inlet opening means in the end plate.
